(19) United States
(12) Patent Application Publication
(10) Pub. No.: US 2009/0028205 A1
(43) Pub. Date: Jan. 29, 2009

(54) DISPERSION COMPENSATOR, SOLID-STATE LASER APPARATUS USING THE SAME, AND DISPERSION COMPENSATION METHOD

(75) Inventor: Tadashi KASAMATSU, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/179,867

(22) Filed: Jul. 25, 2008

(30) Foreign Application Priority Data
Jul. 27, 2007 (JP) 2007-195621

(51) Int. Cl. H01S 3/08; G02B 5/08

(52) U.S. Cl. 372/99; 359/861; 359/862

(57) ABSTRACT

A dispersion compensator which is compact, low loss, low cost, and highly stable, and yet capable of varying the dispersion compensation amount without changing the output position of an output beam. The dispersion compensator includes: a first and a second planar mirrors disposed parallel to each other, wherein at least either one of the mirrors has group velocity dispersion whose value varies according to the incident angle of light incident on the mirror; a mirror holding means rotatably holding the first and second mirrors in a direction in which the incident angle of light incident on the first mirror is changed while maintaining the parallel state of the mirrors; and a third mirror disposed so as not to be rotated with the first and second mirrors and reflects light reflected sequentially by the first mirror and the second mirror.

### BACKGROUND OF THE INVENTION

1. Field of the Invention

The present invention relates to a dispersion compensator that gives group velocity dispersion in a laser resonator and a dispersion compensation method. The invention also relates to a solid-state laser apparatus having the dispersion compensator described above.

2. Description of the Related Art

Dispersion compensators in which a solid-state laser medium doped with a rare earth ion (or a transition metal ion) is excited by excitation light emitted from a semiconductor laser (LD) and the like have been actively developed. Among them, so-called short pulse lasers having a pulse width in the range from picoseconds to femtoseconds have been proposed in many application areas including medicine, biology, machine industry, and measurement fields, and some of them are put into practical use after verification. These lasers generate ultrashort pulses through so-called mode locking. To put it briefly, the mode locking is a phenomenon in laser oscillation in which all phases of multi-longitudinal modes are locked (relative phase difference=0) in the frequency domain, and ultrashort pulses are generated by multimode interference between longitudinal modes in the time domain.

Several different methods for realizing the mode locking have been proposed so far. More specifically, mode locking methods using Kerr-lens effect based on nonlinear refractive index of a laser medium, semiconductor saturable absorbing mirror (SESAM), nonlinear light polarization rotation, acoustooptic device, and the like may be cited. Each of these methods has a function to forcibly lock the phases of longitudinal modes of laser oscillation.

In a so-called ultrashort pulse laser having a pulse width below picosecond, it is known that the wavelength spreading (spectral width) of a light pulse extends to several to several dozens of nanometers and the pulse width is expanded by positive wavelength dispersion (group velocity dispersion) of optical components such as laser crystals and resonator mirrors when the light pulse travels round in a laser resonator.

Conventionally, it is practiced to give negative group velocity dispersion (hereinafter, simply referred to as “negative dispersion” or “dispersion”) in the resonator in order to correct this phenomenon and obtain a short pulse, which is known as dispersion compensation. Generally, in order to obtain a pulse width less than several hundreds of femtoseconds, the dispersion compensation is an essential technology. The amount of dispersion compensation that should be given is not arbitrary, but an optimum value exists according to the laser operating condition. In soliton mode locking, which is one of the mode locking methods, the mode locking phenomenon occurs only when dispersion is compensated in a resonator and the pulse width is compressed in combination with self-phase modulation effect.

Accordingly, in order to obtain a Fourier transform limit pulse determined by the wavelength range, optimization in the amount of dispersion compensation is essential. In the mean time, in order to implement dispersion compensation within a resonator, it is desirable that a small component having an extremely low optical loss be used. In addition, low cost and high stability are also important conditions to realize a practical ultrashort pulse laser.

A several methods have been proposed so far for dispersion compensation. For example, a method using a pair of prisms as described, for example, in Japanese Unexamined Patent Publication No. 8 (1996)-264869, and a method using a pair of diffraction gratings as described, for example, in U.S. Pat. No. 5,867,304 are commonly known. Recently, a method using a chirp mirror, which is a high reflection mirror coated with a multilayer dielectric film having different admission depths with respect to each wavelength used in a resonator has been proposed as described, for example, in Japanese Unexamined Patent Publication Nos. 2006-352614 and 2006-030288. Further, a method using a Gires-Tournois interferometer (GTI) and an applied method thereof using a GTI mirror is also known as described, for example, in “Compression of femtosecond optical pulses with dielectric multilayer interferometers”, J. Kuhl and J. Heppner, IEEE Journal on Quantum Electronics, Vol.22, Issue 1, pp. 182-185, 1986 (Non-patent Document 1). Non-patent Document 1 also describes a method for realizing variable dispersion by rotating negative dispersion mirrors disposed in parallel.

So far, however, an optical component having a size allowing insertion in a resonator and variability in the amount of dispersion compensation with low loss, low cost, and high stability has not been proposed yet.

For example, where a prism pair, typically SF10 prism, is used, it is necessary to set the distance between the prisms around 10 to 50 cm in order to generate a normally required negative dispersion amount of around −1000 to −5000 fs², forcing the resonator to have a length about that size. An increased resonator length is likely to induce an increased size of laser equipment and instability due to mechanical variations.

In the mean time, employment of the diffraction grating pair causes significant attenuation in laser output due to optical power loss of inserted diffraction grating pair since the diffraction efficiency thereof is around 80% at a maximum.

Employment of the chirp mirror does not cause any problem with respect to insertion loss since it has a reflectance value corresponding to that of an ordinary high reflectance dielectric multilayer mirror (99.9%) and size. But, variability of dispersion compensation is compromised, since the compensation amount is limited to the predetermined value coated on the mirror.

Employment of the GTI may allow a reduced size, low loss and variability of dispersion compensation. But, it is necessary to control an extremely small gap by a piezoelectric device which results in an increased cost of laser equipment. In addition, the laser operating point varies due to spatial drift of the piezoelectric device, which poses a question on the long term stability of the laser operation.

The conventional method in which a pair of negative dispersion mirrors disposed in parallel is rotated has a problem that the output position of an output beam is displaced largely as the mirrors are rotated. Consequently, where this configuration is disposed in a laser resonator, it is necessary to readjust optical alignment of the laser oscillator according to the mirror rotation, which is extremely inconvenient.

The present invention has been developed in view of the circumstances described above, and it is an object of the present invention to provide a dispersion compensator which is compact, low loss, low cost, and highly stable, and yet capable of changing the dispersion compensation amount without varying the output position of an output beam.

It is a further object of the present invention to provide a dispersion compensation method using the dispersion compensator described above.

It is a still further object of the present invention to provide a solid-state laser apparatus which includes the dispersion compensator described above and is capable of stably outputting an ultrashort pulse laser.

### SUMMARY OF THE INVENTION

A first dispersion compensator according to the present invention is a dispersion compensator including: a first and a second planar mirrors disposed parallel to each other, wherein at least either one of the mirrors has group velocity dispersion whose value varies according to the incident angle of light incident on the mirror; a mirror holding means holding the first and second mirrors parallel to each other; and a third mirror that reflects light reflected sequentially by the first mirror and the second mirror.

It is particularly preferable that the mirror holding means holding the first and second mirrors parallel to each other is rotatable in a direction in which the incident angle of light incident on the first mirror is changed while maintaining the parallel state of the mirrors. In this case, preferably, a drive means that rotates the first and second mirrors held by the mirror holding means is further provided.

Further, in the first dispersion compensator, it is preferable that a means that changes the distance between the first and second mirrors while maintaining the parallel state of the mirrors is further provided. In this case, preferably, a drive means that drives the means that changes the distance between the first and second mirrors is further provided.

Still further, in the first dispersion compensator, it is preferable that the third mirror has group velocity dispersion.

Further, in the first dispersion compensator according to the present invention, the first and second mirrors are disposed such that light incident on the mirrors is reflected a plurality of times by each of the mirrors.

Still further, in the first dispersion compensator according to the present invention, it is preferable that the second mirror has negative group velocity dispersion, and the value of the negative group velocity dispersion varies along a direction on the second mirror in which the light incident position is changed.

Further, in the first dispersion compensator according to the present invention, it is preferable that an optical substrate having two parallel faces is further provided and the first and second mirrors are formed of coatings applied on the two parallel faces respectively.

A second dispersion compensator according to the present invention is a dispersion compensator including:

a planar mirror having group velocity dispersion whose value varies according to the incident angle of light incident on the mirror;

a mirror holding means holding the planar mirror; and

a concave mirror with the incident point of the light incident on the planar mirror as the center of curvature thereof.

In the second dispersion compensator, it is preferable that the planar mirror holding means is rotatably formed centered on the light incident point. In this case, preferably, a drive means that rotates the planar mirror holding means is further provided.

A solid-state laser apparatus according to the present invention includes a resonator and the first or second dispersion compensator provided inside of the resonator.

A first dispersion compensation method according to the present invention is a method that uses a dispersion compensator that includes: a first and a second planar mirrors disposed parallel to each other, wherein at least either one of the mirrors has group velocity dispersion whose value varies according to the incident angle of light incident on the mirror; a mirror holding means rotatably holding the first and second mirrors in a direction in which the incident angle of light incident on the first mirror is changed while maintaining the parallel state of the mirrors; and a third mirror disposed so as not to be rotated with the first and second mirrors and reflects light reflected sequentially by the first mirror and the second mirror, the method including the steps of:

first, rotating the mirror holding means to adjust dispersion compensation to an intended amount for the incident light; and

then, causing the mirror holding means not to be rotatable to fix the dispersion compensation state.

A second dispersion compensation method according to the present invention is a method that uses a dispersion compensator which includes:

a planar mirror having group velocity dispersion whose value varies according to the incident angle of light incident on the mirror; a mirror holding means rotatably holding the planar mirror centered on the light incident point; and a concave mirror disposed so as not to be rotated with the planar mirror and with the incident point as the center of curvature thereof, the method including the steps of:

first, rotating the mirror holding means to adjust dispersion compensation to an intended amount for the incident light; and

then, causing the mirror holding means not to be rotatable to fix the dispersion compensation state.

The first dispersion compensator according to the present invention includes a first and a second planar mirrors disposed parallel to each other, wherein at least either one of the mirrors has group velocity dispersion whose value varies according to the incident angle of light incident on the mirror, and a mirror holding means holding the first and second mirrors parallel to each other, so that if the first and second mirrors are rotated in a direction in which the incident angle of light incident on the first mirror is changed, the incident angle of light incident on the mirrors is changed. In this way, as a result of the change in the incident angle of the light with respect to the first and/or second mirror having group velocity dispersion, the dispersion compensation amount may be changed freely according to the rotation angle.

Further, a third mirror that reflects light reflected sequentially by the first mirror and the second mirror is further provided, so that the light reflected by the third mirror is returned along the optical path of the light incident on the first mirror in the opposite direction regardless of the rotation angle of the first and second mirrors. In this way, the output position of light exiting from the dispersion compensator is not changed and always maintained constant.

In the first dispersion compensator according to the present invention, if the third mirror has group velocity dispersion, the third mirror may also involve the dispersion compensation, so that where the dispersion compensation amount by the first and/or second mirror is insufficient, the insufficient amount may be compensated by the third mirror.

Further, in the first dispersion compensator according to the present invention, if a means that changes the distance between the first and second mirrors while maintaining the parallel state of the mirrors is provided, the position on the third mirror where light is incident may be maintained constant by changing the distance. Where a partial transmission mirror is used as the third mirror and light transmitted through the mirror is detected for automatic power control (APC) of a solid-state laser, if the position of light incident on the third mirror (output position of light transmitted through the mirror) changes, such problem that the light misses the light receiving surface of the light detector may possibly occur. But if the position of the light incident on the third mirror is maintained constant in the manner as described above, such problem may be prevented.

Still further, in the first dispersion compensator according to the present invention, if the second mirror has group velocity dispersion and the value of the group velocity dispersion varies along a direction on the second mirror in which the light incident position is changed when rotated, the dispersion compensation amount that varies with the mirror rotation may further increased or reduced. This allows the dispersion compensation amount to be varied sharply or slowly with respect to unit rotation angle of the mirror.

In the mean time, the second dispersion compensator according to the present invention includes a planar mirror having group velocity dispersion whose value varies according to the incident angle of light incident on the mirror, and a mirror holding means holding the planar mirror, so that if the planar mirror is rotated centered, for example, on the light incident point, the incident angle of light incident on the mirror is changed. In this way, as a result of the change in the incident angle of the light with respect to the planar mirror having group velocity dispersion, the dispersion compensation amount may be changed freely according to the rotation angle.

Further, a concave mirror with the incident point of the light incident on the planar mirror as the center of curvature thereof is further provided, so that the light reflected by the concave mirror is returned along the optical path of the light incident on the concave mirror in the opposite direction, and further returned along the optical path of the light incident on the planar mirror in the opposite direction regardless of the rotation angle of the planar mirror. In this way, the output position of light exiting from the dispersion compensator is not changed and always maintained constant.

It is noted that the first and second planar mirrors held by the mirror holding means in the first dispersion compensator, and the planar mirror held by the mirror holding means in the second dispersion compensator can be rotated manually, but if drive means for driving these mirrors are provided, the mirrors can be rotated automatically.

As described above, the first and second dispersion compensators according to the present invention have very simple structures so that they are formed compact with low cost.

Further, the first and second dispersion compensators according to the present invention do not require a high accurate moving part like that for controlling an etalon gap. From this viewpoint also, they are formed at low cost as well as having high stability.

Still further, the first and second dispersion compensators according to the present invention do not include an element that cause a large optical power loss, such as a diffraction grating, so that they can be low-loss devices.

The solid-state laser apparatus according to the present invention includes a resonator and either one of the dispersion compensators according to the present invention provided inside of the resonator, so that it is capable of stably outputting an ultrashort pulse laser by setting the dispersion compensation to an appropriate amount.

The first dispersion compensation method according to the present invention is a method that uses a dispersion compensator which includes: a first and a second planar mirrors disposed parallel to each other, wherein at least either one of the mirrors has group velocity dispersion whose value varies according to the incident angle of light incident on the mirror; a mirror holding means rotatably holding the first and second mirrors in a direction in which the incident angle of light incident on the first mirror is changed while maintaining the parallel state of the mirrors; and a third mirror disposed so as not to be rotated with the first and second mirrors and reflects light reflected sequentially by the first mirror and the second mirror, and includes the steps of: first, rotating the mirror holding means to adjust dispersion compensation to an intended amount for the incident light; and then, causing the mirror holding means not to be rotatable to fix the dispersion compensation state. This ensures the intended amount of dispersion compensation to be obtained and maintained.

The second dispersion compensation method according to the present invention is a method that uses a dispersion compensator which includes: a planar mirror having group velocity dispersion whose value varies according to the incident angle of light incident on the mirror; a mirror holding means rotatably holding the planar mirror centered on the light incident point; and a concave mirror disposed so as not to be rotated with the planar mirror and with the incident point as the center of curvature thereof, and includes the steps of:

first, rotating the mirror holding means to adjust dispersion compensation to an intended amount for the incident light; and

then, causing the mirror holding means not to be rotatable to fix the dispersion compensation state. This method also ensures the intended amount of dispersion compensation to be obtained and maintained.

### BRIEF DESCRIPTION OF THE DRAWINGS

FIG. 1 is a schematic side view of a dispersion compensator according to a first embodiment of the present invention.

FIG. 2 is a graph illustrating the relationship between wavelength of light and group velocity dispersion.

FIG. 3 is a schematic side view of a solid-state laser apparatus according to a second embodiment.

FIG. 4 is a graph illustrating the relationship between group velocity dispersion and pulse width.

FIG. 5 is a schematic side view of a dispersion compensator according to a third embodiment of the present invention.

FIG. 6 is a schematic side view of a dispersion compensator according to a fourth embodiment of the present invention.

FIG. 7 illustrates an operation of the dispersion compensator shown in FIG. 6.

FIG. 8 is a schematic side view of a dispersion compensator according to a fifth embodiment of the present invention.

FIG. 9 is a schematic side view of a dispersion compensator according to a sixth embodiment of the present invention.

FIG. 10 is a schematic side view of a solid-state laser apparatus according to a seventh embodiment.

FIG. 11 is a schematic side view of a dispersion compensator according to an eighth embodiment of the present invention.

### DESCRIPTION OF THE PREFERRED EMBODIMENTS

Hereinafter, exemplary embodiments of the present invention will be described in detail with reference to the accompanying drawings.

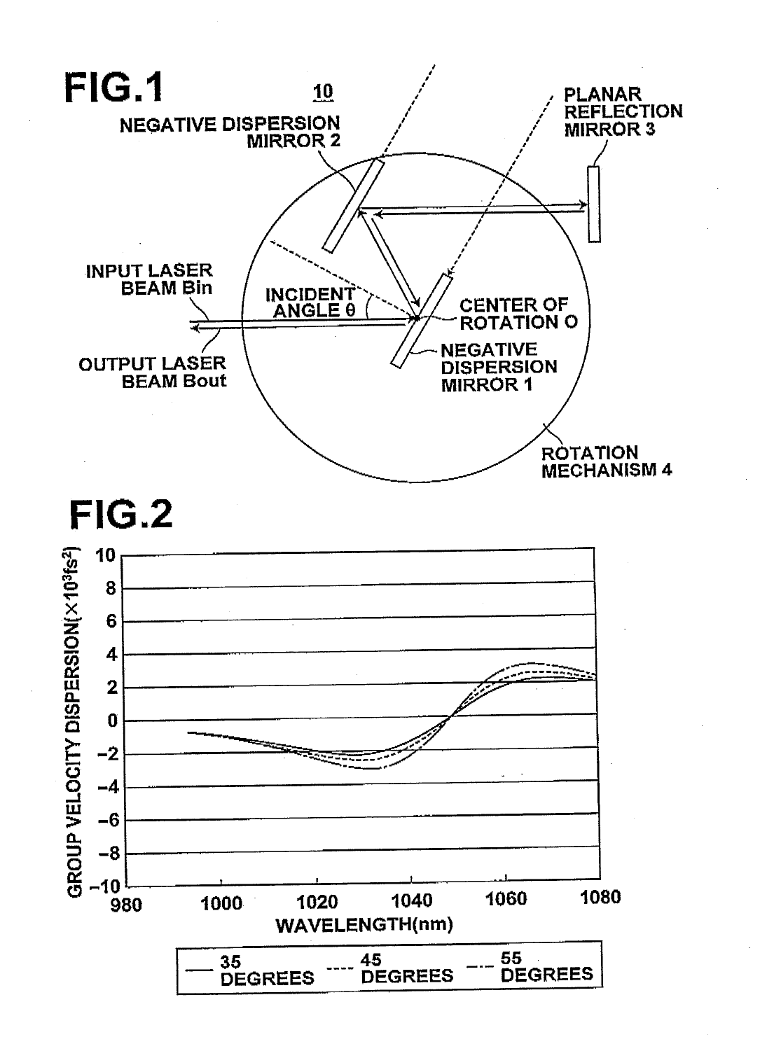

FIG. 1 illustrates a variable dispersion compensator 10 according to a first embodiment. The variable dispersion compensator 10 includes so-called GTI mirrors using etalon interference as negative dispersion mirrors (dispersion compensation mirrors). However, any type of mirrors other than the GTI mirrors may also be used as long as they provide negative dispersion which is dependent on incident angle.

A negative dispersion mirror 1 (first mirror) and a negative dispersion mirror 2 (second mirror) of the type described above are disposed parallel to each other on a rotation mechanism 4 rotatable around a center of rotation O. A planar reflection mirror 3 is disposed outside of the rotation mechanism 4 as a third mirror such that light from the negative dispersion mirror 2 is incident thereon at normal incidence. The optical path of an input laser beam Bin is set so as to incident on the negative dispersion mirror 1. In the present embodiment, the center of rotation O of the rotation mechanism 4 is set adjacent to the incident point of the input laser beam Bin on the negative dispersion mirror 1. But, it is not necessarily required and the center of rotation O may be set at an appropriate position.

The input laser beam Bin is reflected by the negative dispersion mirror 1 and incident on the negative dispersion mirror 2, then reflected thereby and incident on the planar reflection mirror 3. The laser beam reflected by the planar reflection mirror 3 (output laser beam Bout) is sequentially reflected by the negative dispersion mirror 2 and the negative dispersion mirror 1, then propagates along the optical path of the input laser beam Bin in opposite direction.

In this configuration, if the rotation mechanism 4 is rotated manually or automatically by a drive means, the incident angles of the laser beam incident on the negative dispersion mirror 1 and negative dispersion mirror 2 are changed, so that the amount of dispersion is changed as described later. The amount of dispersion is a negative dispersion amount that compensates for positive wavelength dispersion of optical components, such as a laser crystal, a resonator mirror and the like, that is, a dispersion compensation amount.

The distance between the negative dispersion mirror 1 and the negative dispersion mirror 2 is determined only by a spatial arrangement of the optical path and independent of the dispersion compensation amount. Typically, the distance is in the order of millimeters (5 to 20 mm), but not limited to this. If the beam arrangement shown in FIG. 1 is allowed, the distance may be determined arbitrarily within a range which is a function of the beam diameter and incident angle. Likewise, the size of the negative dispersion mirrors 1 and 2 may be arbitrarily determined within a range which allows the spatial beam arrangement.

It is noted that either one of the negative dispersion mirrors 1 or 2 may be an ordinary positive or zero dispersion mirror. Here, a high reflection mirror is used as the planar reflection mirror 3, but a partial transmission mirror may be used in some cases.

FIG. 2 shows results of theoretical calculation of wavelength dependence of the negative dispersion mirrors 1 and 2 based on the theory describing the characteristics of the GTI mirror (Non-patent Document 1). FIG. 2 shows that a dispersion amount of about −2540 fs² can be obtained around a wavelength of 1030 nm at an incident angle of 45 degrees. In the mean time, when the incident angle is changed from 45 degrees to −10 and +10 degrees, dispersion amounts of −2210 fs² (+330 fs² with respect to 45 degrees) and −3070 fs²(−530 fs²with respect to 45 degrees) maybe obtained respectively, thereby a dispersion variable width of 860 fs² may be obtained.

The above description is the characteristics of one mirror. In the configuration shown in FIG. 1, a center dispersion amount of −10160 (=2540×4) fs² with a variable width of 3440 (=860×4) fs² may be obtained in reciprocation at an incident angle of 45 degrees. The center dispersion amount is slightly greater than an optimum value, therefore a positive dispersion of about +8000 fs² is given to the planar reflection mirror 3 or other optical elements within the laser resonator, thereby the dispersion amount may be varied from −840 to −4280 fs² in reciprocation with a center dispersion amount of −2160 fs² by changing the incident angle. The positive dispersion of +8000 fs² can also be achieved by other designs of the GTI mirrors.

Various designs of GTI mirrors are possible, and the present embodiment is one example which allows designing of the mirrors having intended angle dependence.

In the configuration of the present embodiment, the negative dispersion mirror 1 and negative dispersion mirror 2 are disposed parallel to each other and rotated as described above, so that the direction of the input laser bean Bin incident on the planar reflection mirror 3 always becomes parallel with the direction of the input laser beam Bin incident on the negative dispersion mirror 1 regardless of the angle of rotation. Accordingly, the output laser beam Bout reflected by the planar reflection mirror 3 always exits from the mirror 3 at right angle so that the output laser beam Bout reflected by the negative dispersion mirror 1 propagates along the optical path of the input laser beam Bin in the opposite direction.

As described above, the output laser beam Bout is always returned to the input side along the same optical path as the input laser beam Bin regardless of the rotation angle of the negative dispersion mirrors 1 and 2, so that the output position thereof is maintained constant. Consequently, the planar reflection mirror may be fixed. Thus, variability of dispersion amount can be realized without changing the optical alignment.

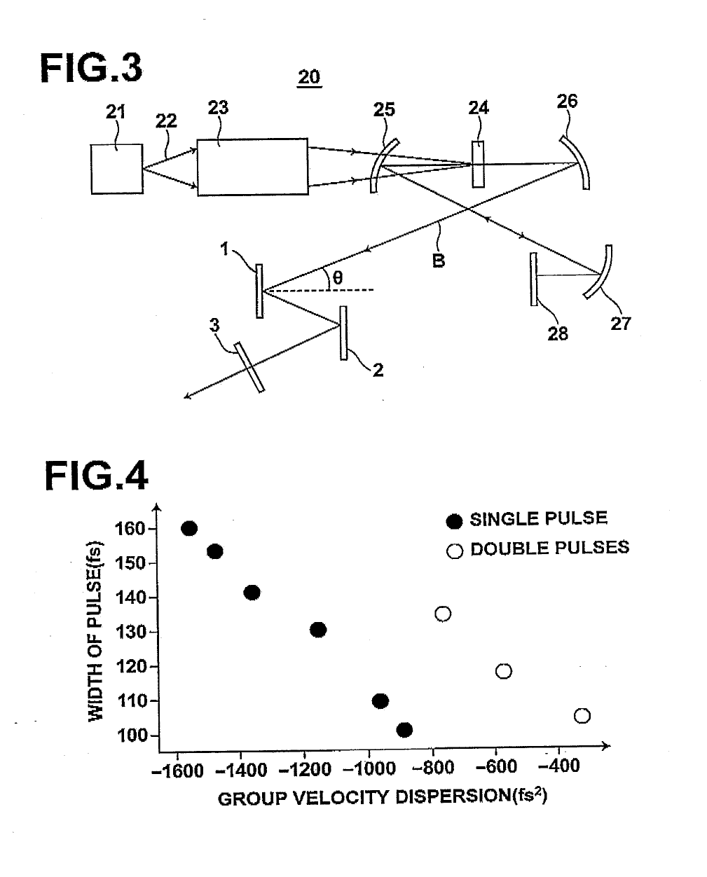

Next, a solid-state laser apparatus 20 according to a second embodiment will be described with reference to FIG. 3. The solid-state laser apparatus 20 is formed with the variable dispersion compensator 10 shown in FIG. 1 inserted in a mode locking laser oscillator, and includes: an excitation laser 21; an excitation optical system 23 that collimates and focuses an excitation laser beam 22 emitted from the excitation laser 21; a laser crystal 24 disposed at a focus position of the excitation laser beam 22 focused by the excitation optical system 23; concave mirrors 25, 26 disposed opposite to each other with the excitation optical system 23 between them; a concave mirror 27 disposed at a position where a solid-state laser beam B reflected by the concave mirror 25 is incident; and a semiconductor saturable absorbing mirror (SESAM) 28 disposed such that the solid-state laser beam B is incident thereon at normal incidence.

As for the excitation laser 21, for example, a semiconductor laser that emits the laser beam 22 with a wavelength of 980 nm is used. The concave mirror 25 has a curvature radius of 100 mm, with an applied coating which is nonreflective to the 980 nm excitation wavelength and highly reflective to the wavelength of 1045 nm of the solid-state laser beam B. As for the laser crystal 24, an Yb:KYW crystal with Yb ion density of 5 at % and a thickness of 1 mm is used. In the meantime, the concave mirrors 26 and 27 have a curvature radius of 100 mm.

The variable dispersion compensator 10 is disposed such that the solid-state laser beam B is incident on the negative dispersion mirror 1. It is noted that the rotation mechanism 4 shown in FIG. 1 is omitted in FIG. 3. Further, as the planar reflection mirror 3, a partial transmission mirror (with an output transmission factor of 1%) which serves as the output mirror of the solid-state laser apparatus 20 is used in FIG. 3, and a resonator is formed between the planar reflection mirror 3 and the semiconductor saturable absorbing mirror 28.

In the solid-state laser apparatus 20, the laser beam 22 with the 980 nm wavelength is focused on the laser crystal 24 by the excitation optical system 23. Then, the resonator transverse mode at the laser crystal 24 is made narrower to around 30 μm in radius by the concave mirrors 25, 26 and CW mode locking is achieved. Further, the resonator mode diameter at the semiconductor saturable absorbing mirror 28 is made smaller by the concave mirror 27 and CW mode locking is achieved. In the configuration described above, a mode-locked laser output of 100 mW was obtained when the power of the excitation laser 21 was 1 W.

The variable dispersion compensator of the present invention is particularly effective where a dispersion compensator is inserted in a laser resonator as illustrated in FIG. 3. Because, it is free from optical axis variations caused by the rotation of the mirror pair and the alignment of the resonator is maintained. Optimization of the amount of dispersion compensation is essential in particular for obtaining a short pulse width. FIG. 4 is an example of experiment illustrating the relationship between the group velocity dispersion and pulse width. It shows that a pulse is split (double pulses) when an absolute value of the group velocity dispersion is smaller than a certain value (here, −900 fs²) while if it is greater, the pulse width is extended. A shortest pulse width of 100 fs is realized only in the vicinity of the dispersion amount of −900 fs². The variable dispersion capability of the variable dispersion compensator 10 may provide the dispersion compensation amount of −900 fs² without disturbing the resonator alignment.

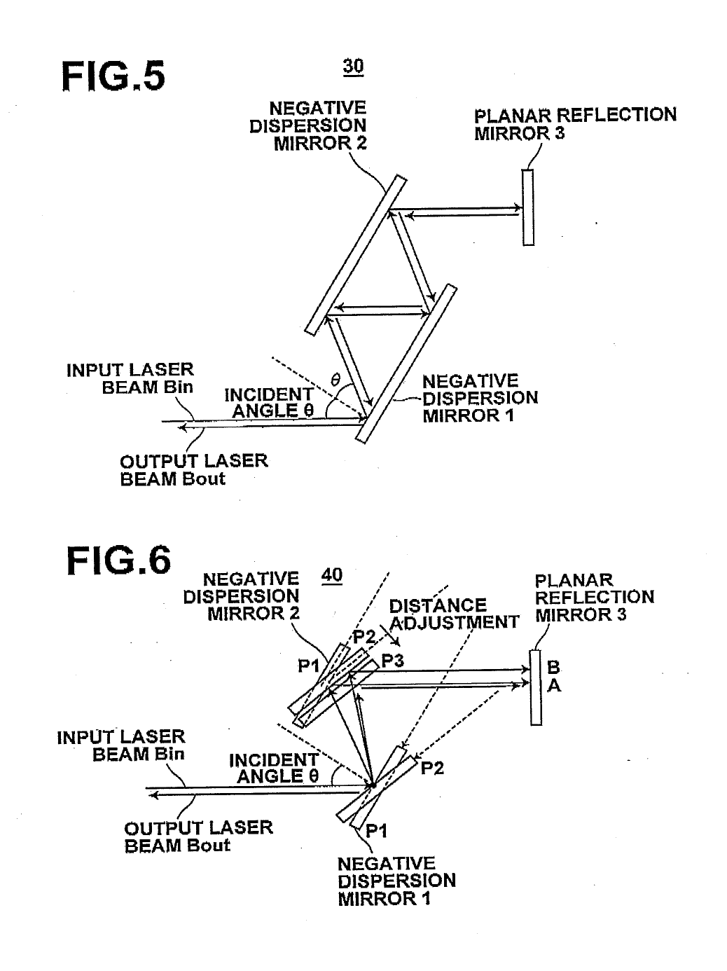

The optimum value of the dispersion compensation is a function of laser medium used, excitation density, output coupling ratio of output mirror, internal loss, wavelength range and the like, and varies largely. Where the absolute value of dispersion amount is insufficient, it is desirable to cause multiple reflections to occur between the negative dispersion mirrors 1 and 2 as in a variable dispersion compensator 30 according to a third embodiment illustrated in FIG. 5. That is, the amount of dispersion in reciprocation may be increased by increasing the number of reflections in this way.

Further, the variable amount provided by the negative dispersion mirrors 1 and 2 is limited. Therefore, it is conceivable to give a fixed amount of dispersion to the planar reflection mirror 3 so that an optimum value of dispersion falls within a dispersion amount range covered by the dispersion compensator.

A variable dispersion compensator 40 according to a fourth embodiment illustrated in FIG. 6 may keep the incident position of the input laser beam Bin on the planar reflection mirror 3 constant even when the incident angle of the input laser beam Bin with respect to the negative dispersion mirrors 1 and 2 is changed. That is, the fourth embodiment includes a means that changes the distance between the negative dispersion mirrors 1 and 2 while maintaining the parallel relationship thereof. By changing the distance between the negative dispersion mirrors 1 and 2 in the manner as described above, the position on the planar reflection mirror 3 where the input laser beam Bin is incident may be maintained constant.

More specifically, when the positions of the negative dispersion mirrors 1 and 2 are changed from the positions P1 in FIG. 6 to the positions P2, the position on the planar reflection mirror 3 where the input laser beam Bin is incident should vary from position A to position B in a normal case. Here, if the positions of the negative dispersion mirrors 1 and 2 are changed to the positions P3 to reduce the distance between them, the position on the partial transmission mirror 3 where the input beam Bin is incident may be kept at position A.

In this way, for example, where the planar reflection mirror 3 is the output mirror formed of a partial transmission mirror, advantageous effects may be obtained that the position of a beam outputted from the output mirror 3 does not change when dispersion is varied. If the position of laser beams outputted from the planar reflection mirror 3 is maintained constant in the manner as described above, it becomes unnecessary to adjust the alignment of the optical system that handles outputted laser beams, which is highly advantageous.

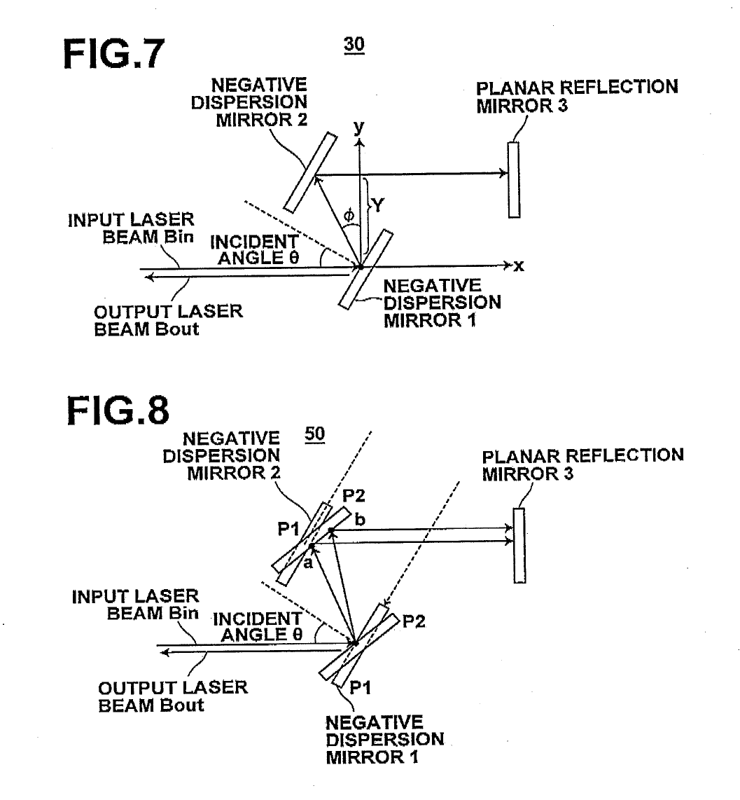

More specifically, as illustrated in FIG. 7, if the distance between the mirrors is d and the incident angle is θ, a projection Y of a beam incident on the negative dispersion mirror 2 from the negative dispersion mirror 1 on the y axis may be expressed by the formula below, provided that Φ is a rectangular coordinate system parallel to the optical axis.

$$Y = \frac{d cos ( π / 2 - 2 θ )}{cos θ} = \frac{d sin 2 θ}{cos θ}$$

Accordingly, it is only necessary to move the negative dispersion mirror 2, for example, by mounting on an actuator such that a variation in the projection Y with respect to a variation in the incident angle θ is corrected based on the formula above. A movement amount D of the negative dispersion mirror 2 is given by the formula below, though the detailed calculation process is omitted here. Note that θ′ in the formula is the incident angle after rotation.

$$D = \frac{\vert \frac{d sin 2 θ}{cos θ} - cot {θ}^{′} \cdot ( \frac{- d sin 2 θ}{cos θ} \frac{1}{tan 2 {θ}^{′}} ) - d \sqrt{1 + {cot}^{2} {θ}^{′}} \vert}{\sqrt{1 + {cot}^{2} {θ}^{′}}}$$

Next, a variable dispersion compensator 50 according to a fifth embodiment of the present invention will be described with reference to FIG. 8. In the present embodiment, a mirror having a group velocity dispersion distribution on the surface thereof is used as the negative dispersion mirror 2. That is, as the negative dispersion mirror 2 is rotated, the incident position of the input laser beam Bin on the mirror is changed and the amount of negative dispersion of the negative dispersion mirror 2 varies along the changing direction of the incident position.

In this case, the pair of negative dispersion mirrors 1 and 2 is rotated, and the dependence of negative dispersion thereof on the rotation angle is basically utilized, as in the first embodiment. When the disposed state of the negative dispersion mirror 2 is changed from P1 to P2, the position on the negative dispersion mirror 2 where the input laser beam Bin is incident changes from “a” to “b”. When the incident position of the input laser beam Bin is changed in the manner as described above, the negative dispersion amount of the negative dispersion mirror 2 varies accordingly.

As for the negative dispersion mirror, a negative dispersion mirror having a group velocity dispersion slope on the surface like that described in Japanese Unexamined Patent Publication No. 2006-030288 is preferably used. In this way, the variable range of dispersion becomes the sum of dispersion amount arising from the change in mirror angle and dispersion amount arising from the spot position dependence of dispersion amount, so that the variable range may be increased. Specifically, it is possible to give a negative dispersion variance of around 100 fs² per a beam position change of 1 mm. Where the mirror spacing is 5 mm, if the incident angle is changed from 45 to 55 degrees, the beam spot moves about 2 mm, so that a further variable amount of about 200 fs² may be added to the variable amount arising from the mirror angle.

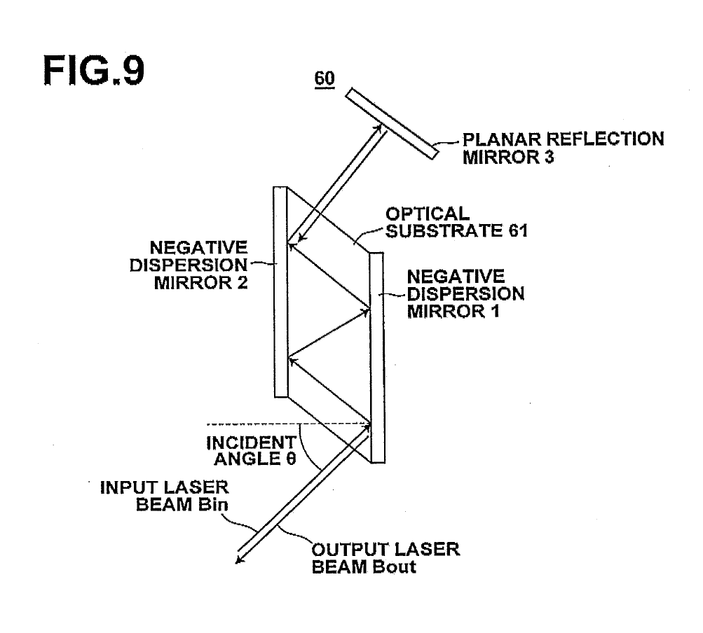

Next, a variable dispersion compensator 60 according to a sixth embodiment of the present invention will be described with reference to FIG. 9. In the present embodiment, negative dispersion mirrors 1 and 2 formed of coatings provided on opposite end sections of a parallel plate optical substrate 61 is used, instead of a separately formed parallel mirror pair. In this case, the parallel mirrors become monolithic, so that the size of the variable dispersion compensator may be reduced further.

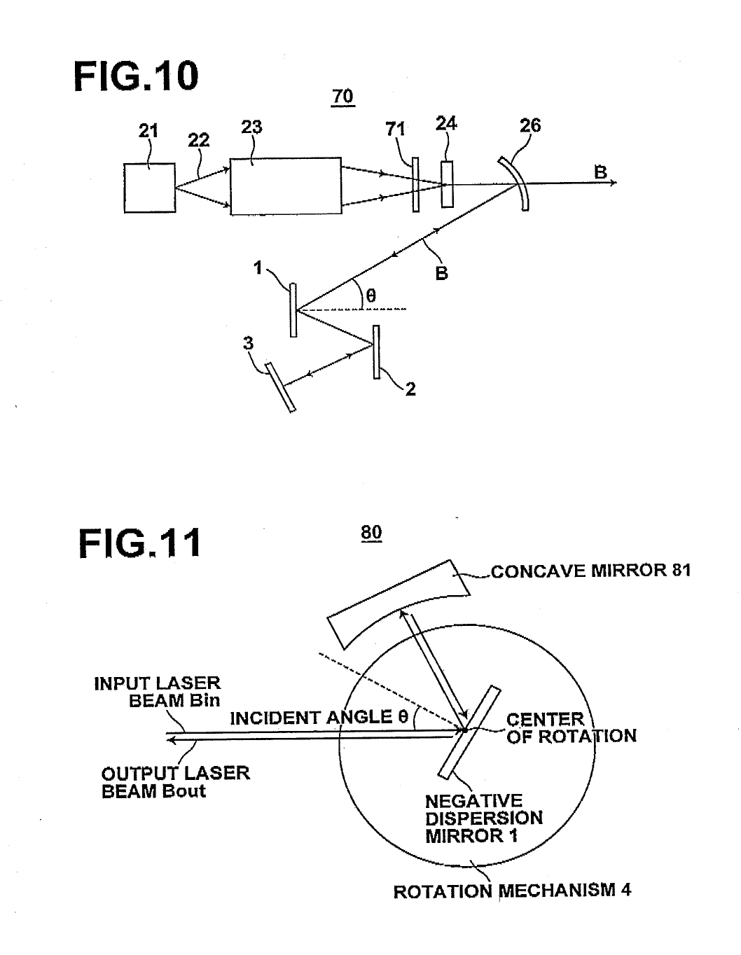

Next, a solid-state laser apparatus 70 according to a seventh embodiment of the present invention will be described with reference to FIG. 10. In the solid-state laser apparatus 70, the laser crystal 24 is disposed closer to the resonator mirror in comparison with the solid-state laser apparatus 20 shown in FIG. 20. That is, the laser crystal 23 is disposed adjacent to a planar mirror 71 forming one resonator mirror, or forms a resonator mirror itself.

In this case, the spatial hole burning effect appears more strongly, and thus it is known that more fine optimization of dispersion amount in the mode locking operation is required as described, for example, in “Passive mode locking of thin-disk lasers: effects of spatial hole burning”, R. Paschotta et al., Applied Physics B, Vol.72, No. 3, pp. 267-278, 2001. This configuration is desirable in practical use since the overall size of the resonator may be reduced by disposing the laser crystal 24 adjacent to the resonator mirror, but poses the aforementioned problem.

Consequently, the solid-state laser apparatus 70 employs a resonator structure capable of realizing an optimum mode locking operation by making the dispersion amount highly accurately variable. That is, here, the planar reflection mirror 3 in FIG. 3 is replaced with the semiconductor saturable absorbing mirror 28, and the resonator spot is directed to the laser crystal 24 and semiconductor saturable absorbing mirror 28 by the concave mirror 26.

In this case, however, it is necessary to minimize the resonator spot on the semiconductor saturable absorbing mirror 28 in order to realize CW mode locking. For this purpose, it is necessary to maintain the optical path length from the concave mirror 26 to the semiconductor saturable absorbing mirror 28 to an optimum value (typically, a length substantially corresponding to the curvature radius of the concave mirror 26). The optical path length, however, is slightly changed as the negative dispersion mirrors 1 and 2 are rotated. Consequently, the semiconductor saturable absorbing mirror 28 is provided with a position adjustment function in the optical axis directions to cancel the variation of the optical path length caused by the rotation of the negative dispersion mirrors 1 and 2, thereby the optical path length is maintained constant.

Next, a variable dispersion compensator 80 according to an eighth embodiment of the present invention will be described with reference to FIG. 11. In the variable dispersion compensator 80, the dispersion compensation amount is made variable using only a single negative dispersion mirror, though the variable amount is small. That is, the variable dispersion compensator 80 includes: one negative dispersion mirror 1 having negative group velocity dispersion whose value varies according to the incident angle θ of the input laser beam Bin; a rotation mechanism (mirror holding means) 4 that rotatobly holds the negative dispersion mirror 1 with the incident point of the input laser beam Bin as the center of rotation O; and a concave mirror 81 with the incident point described above as the center of curvature thereof.

In the configuration described above, when the negative dispersion mirror 1 is rotated, the incident angle θ of the laser beam Bin incident on the mirror 1 changes. In this way, as a result of the change in the incident angle of the input laser beam Bin with respect to the negative dispersion mirror 1 having negative group velocity dispersion, the dispersion compensation amount may be changed freely according to the rotation angle.

Further, the configuration includes the concave mirror 81 as described above, so that an output laser beam Bout reflected by the concave mirror 81 is returned along the optical path of the input laser beam Bin incident on the concave mirror 81 in the opposite direction and further along the optical path of the input laser beam Bin incident on the negative dispersion mirror 1 in the opposite direction regardless of the rotation angle of the negative dispersion mirror 1. In this way, the output position of the output laser beam Bout exiting from the variable dispersion compensator is not changed and always maintained constant.

Each of these variable dispersion compensators described above realizes variable negative dispersion in spite of extremely compact (several centimeters or less). Further, each of these variable dispersion compensators does not have a high accurate moving part like that for controlling an etalon gap, so that it is manufactured at low cost and stable over a long period of time.

A first dispersion compensation method according to the present invention may also employ a configuration other than those described above. For example, the following method may also be employed. Namely, a first and a second mirrors are fixed parallel to each other on a first small substrate, then the first substrate is mounted on a second substrate on which other optical members (including a third mirror) of a laser resonator is disposed, the first substrate is rotationally displaced to adjust the position such that an intended incident angle, i.e., an intended dispersion compensation amount is obtained, and the first substrate is fixed at an optimum position.

In order to perform the positional adjustment by rotating the first substrate, for example, the following may be employed.
(1) A configuration in which the first substrate is formed in a circle, then a circular guide groove having the same radius is formed, and the first substrate is rotationally displaced to adjust the position.
(2) A configuration in which a protrusion or a pin is formed on the second substrate and the first substrate is rotationally displaced with the protrusion or pin as the guide to adjust the position.

In the embodiments described above, a negative dispersion compensation element is used as the dispersion compensation element, but the present invention may also use a positive dispersion compensation element.

When chirp pulse amplification is performed on output light from a pulse laser device that outputs a femtosecond order pulse laser with a pulse width of, for example 100 fsec, it is difficult to directly amplify the light because a pulse laser beam with a femtosecond order pulse width has an excessively high peak power. Consequently, the following pulse laser configuration is known. Namely, the pulse width is broadened to about 2 psec to reduce the peak power by a positive dispersion element, then the chirp pulse amplification is performed by a gain of 100 to 1000, and the pulse width is returned to 100 fsec again by a negative dispersion compensation element.

In such a device, use of the dispersion compensator of the present invention as the positive dispersion element allows the rotation angle of the dispersion compensation element, i.e., the dispersion compensation amount to be controlled without changing the output position of light exiting from the dispersion compensator, i.e., while always maintaining the output position constant.

What is claimed is:

1. A dispersion compensator comprising:
a first and a second planar mirrors disposed parallel to each other, wherein at least either one of the mirrors has group velocity dispersion whose value varies according to the incident angle of light incident on the mirror;
a mirror holding means holding the first and second mirrors parallel to each other; and
a third mirror that reflects light reflected sequentially by the first mirror and the second mirror.

2. The dispersion compensator according to claim 1, wherein the mirror holding means holding the first and second mirrors parallel to each other is rotatable in a direction in which the incident angle of light incident on the first mirror is changed while maintaining the parallel state of the mirrors.

3. The dispersion compensator according to claim 2, further comprising a drive means that rotates the mirror holding means in the direction in which the incident angle of light incident on the first mirror is changed.

4. The dispersion compensator according to claim 1, further comprising a means that changes the distance between the first and second mirrors while maintaining the parallel state of the mirrors.

5. The dispersion compensator according to claim 4, further comprising a drive means that drives the means that changes the distance between the first and second mirrors.

6. The dispersion compensator according to claim 1, wherein the third mirror has group velocity dispersion.

7. The dispersion compensator according to claim 1, wherein the first and second mirrors are disposed such that light incident on the mirrors is reflected a plurality of times by each of the mirrors.

8. The dispersion compensator according to claim 1, wherein the second mirror has negative group velocity dispersion, and the value of the negative group velocity dispersion varies along a direction on the second mirror in which the light incident position is changed.

9. The dispersion compensator according to claim 1, wherein the compensator further comprises an optical substrate having two parallel faces, and the first and second mirrors are formed of coatings applied on the two parallel faces respectively.

10. A dispersion compensator comprising:
a planar mirror having group velocity dispersion whose value varies according to the incident angle of light incident on the mirror;
a mirror holding means holding the planar mirror; and
a concave mirror with the incident point of the light incident on the planar mirror as the center of curvature thereof.

11. The dispersion compensator according to claim 10, wherein the planar mirror holding means is rotatably formed centered on the light incident point.

12. The dispersion compensator according to claim 11, further comprising a drive means that rotates the planar mirror holding means.

13. A solid-state laser apparatus comprising:
a resonator; and
the dispersion compensator according to claim 1 provided inside of the resonator.

14. The solid-state laser apparatus according to claim 13, further comprising a substrate for disposing an optical member on which is formed a guide member that rotationally displaceably guides the holding member.

15. The solid-state laser apparatus according to claim 13, further comprising a substrate for disposing an optical member on which is formed a protrusion that rotationally displaceably supports the holding means.

16. A dispersion compensation method that uses a dispersion compensator which includes: a first and a second planar mirrors disposed parallel to each other, wherein at least either one of the mirrors has group velocity dispersion whose value varies according to the incident angle of light incident on the mirror; a mirror holding means rotatably holding the first and second mirrors in a direction in which the incident angle of light incident on the first mirror is changed while maintaining the parallel state of the mirrors; and a third mirror disposed so as not to be rotated with the first and second mirrors and reflects light reflected sequentially by the first mirror and the second mirror, the method comprising the steps of:
first, rotating the mirror holding means to adjust dispersion compensation to an intended amount for the incident light; and
then, causing the mirror holding means not to be rotatable to fix the dispersion compensation state.

17. A dispersion compensation method that uses a dispersion compensator which includes: a planar mirror having group velocity dispersion whose value varies according to the incident angle of light incident on the mirror; a mirror holding means rotatably holding the planar mirror centered on the light incident point; and a concave mirror disposed so as not to be rotated with the planar mirror and with the incident point as the center of curvature thereof, the method comprising the steps of:
first, rotating the mirror holding means to adjust dispersion compensation to an intended amount for the incident light; and
then, causing the mirror holding means not to be rotatable to fix the dispersion compensation state.
